(19) United States
(12) Patent Application Publication
(10) Pub. No.: US 2022/0387897 A1
(43) Pub. Date: Dec. 8, 2022

(54) SYSTEMS AND METHODS FOR VIDEO STREAMING ANALYSIS

(71) Applicant: PLLAY LABS, INC., Huntingdon Valley, PA (US)

(72) Inventors: Shawn GUNN, Huntingdon Valley, PA (US); Christine KRZYZANOWSKI, Huntingdon Valley, PA (US)

(21) Appl. No.: 17/761,571

(22) PCT Filed: Jul. 17, 2020
(86) PCT No.: PCT/US2020/042620

§ 371 Date: Mar. 17, 2022

Related U.S. Application Data
(60) Provisional application No. 62/875,151, filed on Jul. 17, 2019.

(51) Int. Cl. A63F 13/86; A63F 13/87

(52) U.S. Cl. CPC A63F 13/86; A63F 13/87

(57) ABSTRACT

Systems and methods related to video streaming analyses for video game streams are disclosed. In embodiments, soft-ware-based algorithms may be applied to enhance game play, enable improvements to wagering, and applying artificial intelligence and machine learning algorithms to enhance game play experience. In embodiments, video game streams may be received to determine data regarding the video game play. Based on the data, an analysis regarding one or more aspects of the gaming event may be produced, with such aspects including at least one or a game strategy, behavioral information, and prediction, and a recommendation. The analysis can then generate a message to be output to the player of the video game stream.

### CROSS REFERENCE TO RELATED APPLICATIONS

This application claims benefit of U.S. Provisional Patent Application No. 62/875,151, filed Jul. 17, 2019.

### BACKGROUND

Online video game competitions are growing in popularity. A single online video game competition may attract a large quantity of competing players. For example, the players may compete against each other in a tournament and the winner of the tournament may receive a prize. The players may compete against each other from the comfort of their own homes using a variety of devices, such as a computer, a mobile device, a streaming smart TV, or a console-based player. Despite their growing popularity, online gaming competitions do not provide players with an ideal experience. For example, current online gaming competitions may experience a low volume of active players or a low volume of matches between active players. Additionally, one or more players may choose to engage in illicit behaviors, such as cheating or under-age gambling. Current online gaming competitions may also have difficulty certifying a winner or may present players with a confusing user interface. Therefore, improvements in online gaming techniques are needed.

### SUMMARY

The present disclosure relates generally to the fields of video streaming analyses and on-line gaming. Systems and methods may be applicable to enable wagering on peer-to-peer and tournament-style on-line games. An illustrative embodiment employs software-based algorithms for determining a winner of a given match, as well as artificial intelligence (AI) for score validation and determining player skill level and betting odds.

In various embodiments, devices may comprise a video camera, one or more processors; and memory storing instructions to be executed by the one or more processors. Such instructions may cause a computing system or device to receive at least one frame, e.g., from a video camera, associated with a video game stream. Based on the at least one frame, an indication of data associated with the video game stream, e.g., data with respect to an aspect of game play. Then, based on the indication of data an analysis associated with the video game stream is produced, wherein the analysis includes at least one of a game strategy, behavioral information, a prediction, and a recommendation. A message may then be generated based on the analysis associated with the video game, and the message sent to at least one player of the video stream.

Additional features of the inventive system are described below.

### BRIEF DESCRIPTION OF THE DRAWINGS

FIG. 1 is a block diagram of an exemplary system.

FIG. 2 is an exemplary data flow diagram.

FIG. 3 is an exemplary data flow diagram.

FIG. 4 is a flow chart of an exemplary method for video analysis.

FIG. 5 is a block diagram of an exemplary computing device.

### DETAILED DESCRIPTION OF ILLUSTRATIVE EMBODIMENT

A goal of our disclosed system is to provide in the moment, e.g., real-time, cash matches and tournaments to players of on-line games (“gamers”). There are hundreds of millions of such gamers worldwide that compete against each other using computers, mobile devices, streaming smart TVs, and console-based players. The disclosed systems and methods may be applied to various gaming systems to address a plurality of problems related to current on-line gaming systems, such as Under Age Gambling, Low Active Player/Match Volumes, increasing user engagement, improving user interfaces and transactions, reducing cheating and creating an even playing field for all users, and providing winner certifications, such as a match winner verification system.

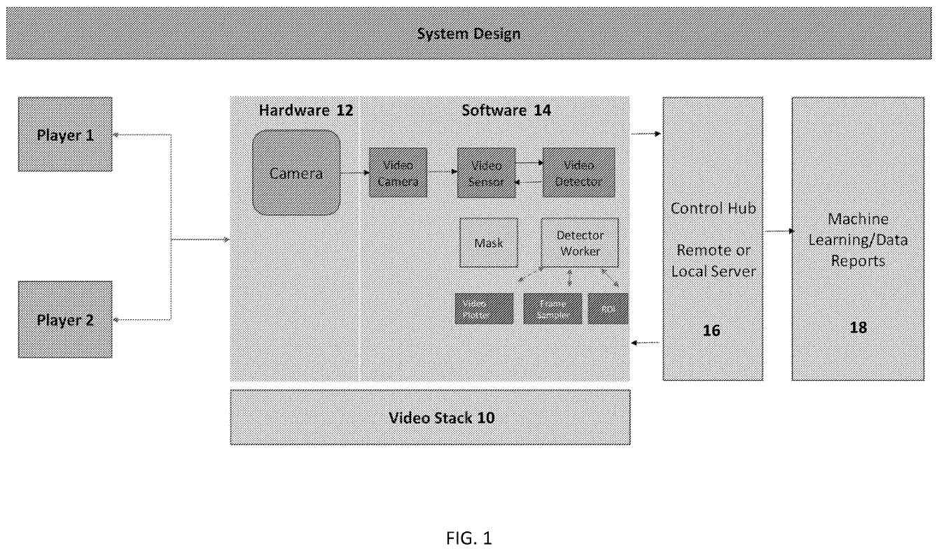

As illustrated in FIG. 1, the system may include a video stack 10, which comprises hardware 12 and software 14. The hardware includes a video camera. The software includes video camera software, a video sensor, and a video detector. The video sensor includes a mask, and the video detector includes a detector worker, which in turn includes a video plotter, frame sampler, and region of interest (ROI). The system also includes a control hub 16, which runs on a remote or local server, and a machine learning/data reports module 18.

Players may interact with hardware 12, which includes the video camera, and other players during the course of a game. Images captured by the camera can be processed by one or more software modules directed toward aspects such as the video camera, a video sensor, and video detector. Software 14 additionally includes a mask, and a detector worker, which exchanges information via one or more computer processors with regard to video plotters, frame samplers, and regions of interest. The video stack 10, associated with both the hardware 12 and software 14, work to process the plurality of video images and scenes comprising gameplay.

Gameplay data and metadata, as further discussed below, may be exchanged with the control hub 16, located at a remote or local server, or a plurality of servers which may be remote and/or local. The control hub 16 processes the gameplay data and meta data to generate one or more machine learning/data reports 18. These reports may be indicative of player, gaming, and wagering trends, insights that can be used to improve the player experience. In an example, a player's actions within a game may be analyzed in association with one or more video streams related to the game play. Such actions and interactions can be processed and applied to a machine learning algorithm to provide insight regarding, for example, the player's gaming ability, skill level, scoring, gameplay trends, etc., as discussed herein.

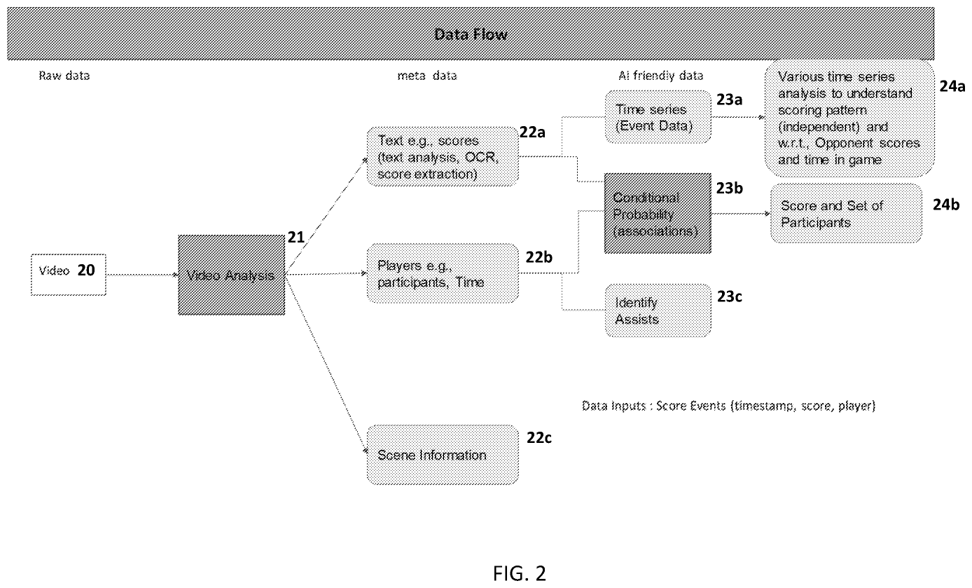

FIG. 2 illustrates a flow chart regarding data processing in accordance with embodiments discussed herein. As a high level overview, raw data, e.g., video data, is processed to generate metadata, which can consequently be used in one or more AI and machine learning analyses to generate gaming and player insights. In various embodiments, the raw data is video data 20, as discussed with respect to FIG. 1. Video data 20 may include gaming data on one or more display devices, and include streaming games, match, and event content. Video data 20 may be from Twitch, YouTube or other content streaming or gaming service. In an example a company, e.g., PLLAY, can provide content directly to players, stream the content, develop its own in the future and stream the content directly.

Video Analysis 21 is then performed on the video data to create Meta Data, and machine learning and AI solutions will ingest the video content on the edge (real-time) to parse into initial meta data buckets. In embodiments, the initial meta data buckets are scores 22a, Players/Participants 22b, and Scene Information 22c.

The Scores bucket 22a relates to scoring data with respect to particular games. In embodiments, each video game provides scoring data in particular areas of the game's user interface, and such information is applied to AI and machine learning algorithms. In examples, the scores include text, such as alphanumeric representations indicative of a player score in a game. Such scores can be derived from the video data using, for example, text analysis, optical character recognition (OCR), score extraction, and a plurality of other means.

In embodiments, the AI engine to understand where this scoring data is located in the user interface (UI) for ingestion. The location of the scoring data may be assigned or extracted a particular based on the type of game, user input, and so forth.

While scores and scoring events are very important for winner verification, they can also be leveraged in embodiments, through the AI and machine learning aspects, to provide information regarding gaming patterns and insights. In examples, based on probability of winning the match at any given time during the match, wager increase events can be determined, provided to the player, or utilized in other aspects of the game to improve overall gameplay. In an example: “Shawn you just scored 7 baskets in a row; would you like to double down your original wager?”

In the Players/Participants bucket 22b, information can be provided by the user within the gaming platform, which can be a desktop app, mobile app, or other means through which the a game can be displayed to a player. Users may store their relevant gamer tag and/or user name for each platform interacts with in the data flow. Such examples may include user names, avatars, and/or other user identifiers with regard to Twitch, Xbox, PS4, PayPal.

In a third bucket, Scene Information 22c can be obtained. Such scene information relates to behavioral monitoring and analytics based on the video streams and analyses from the raw data. As discussed herein, with regard to various computing and gaming systems on which the present invention may be implemented, scene information may extract one or more features or identifiers from the video stream, which are indicative of an item of interest, or item to be tracked.

In examples, scene information may overlap with information obtained from on or more other buckets. Scene information may take a gaming scene display comprising a user score or other piece(s) of information related to user gameplay that are visible on the scene display, i.e., video stream. Such visual data can be obtained and applied to any of the AI and machine learning algorithms set forth herein.

Continuing with the data flow of FIG. 2, with respect to the scores bucket 22a and the Players/Participants bucket 22b, the information may utilized to develop AI friendly data. In other words, the AI and machine learning technology can take the meta data information, and both track and learn how a user plays a video gaming under all play conditional, against various skill levels and betting patterns. This data will be used to provide a robust data analytics subscription services that will help peer-to-peer users understand their opponent's habits in the short-term. Mid-longer term, the platform will leverage this information for 3rd party wagers, which will leverage these analytics in the same fashion a financial investor uses data to buy options for stocks.

With the scoring bucket 22a for example, such scoring information may be utilized to analyze Time series event data 23a. In examples, a players score may be analyzed over a period of time, with respect to particular events occurring within a game, based on a game play time, game play length, or other similar time series data sets. In addition, the AI friendly data can relate to a Conditional Probability and association for particular events to occur, given the scoring data obtained from the scoring bucket 22a.

Such AI/machine learning applications may be applied to various gaming data obtained from the scores bucket, and include aspects such as text analyses, extracted scores, and other associations between the players gaming and their progress, score, or other gaming measurement.

With regard to the Players/Participants 22b buckets, the conditional probability data analysis 23b can also be applied to the meta data set. In addition, the algorithms can identify patterns, trends, and insights with respect to certain actions taken by one or more players with the game. For example, the data can be utilized to Identify Assists 23c. In some examples, this may apply when there are team games, or otherwise gaming events where a plurality of players are playing and/or interacting with each other.

The AI friendly data can be further leveraged to gain additional insights and trends with respect to gaming events. Regarding the Time series and event data 23a application of the meta data from the scoring bucket 22a, various time series analyses may be provided to understand scoring patterns. In an example, scoring patterns may be determined independently and/or dependently with respect to one or more other factors, such as an opponent's scores, a time spent in a game, etc. Such insights, wherein the data regarding a particular user's game play can be compared to other players, or other factors, e.g., opponent scores, time, etc., can provide a closer look into gaming patterns applicable to that particular user, and even expanded to general insights regarding overall gaming activity.

To provide just a few examples, with regard to the AI Strategies/Coach/Customer Service Agent 24a, 24b, the platform may leverage at least one or more of real-time and historical match, user behavioral, betting data to enable an assistant, such as a neural voice-base assistant. This assistant will remove the need for UI only presentation of relevant data or key decision-making moments, which will allow the user to remain focused on the gaming/betting task in-match.

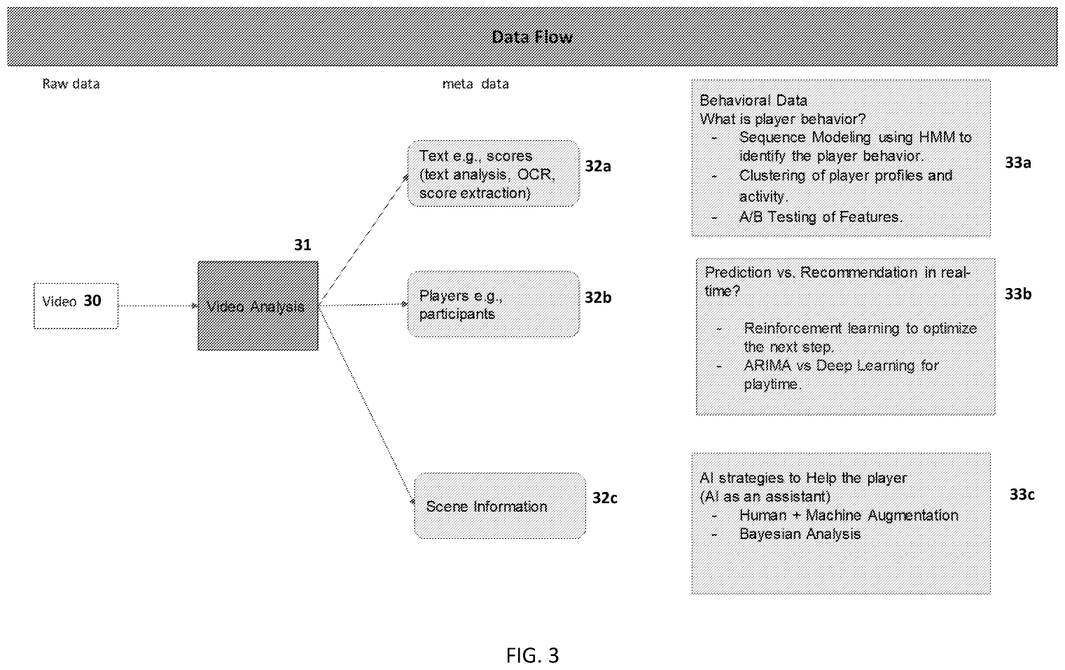

FIG. 3 expands upon the data flow, and the process of the raw video data 30 being received by the video analysis module 31, and generating meta data to be further processed and provide insights. In the non-limiting example depicted by the flow chart, raw video data creates three types of metadata, including text 32a relating to scores; players 32b; and scene information 32c. This enables the system to create player behavioral data 33a; real-time predictions and recommendations 33b; and strategies to assist the player 33c.

Behavioral data 33a is directed toward analyzing player behavior during game play. In examples, sequence modeling using one or more models, such as Human Markov Model (HMM) can identify player behavior. The identification of this behavior can be based on the video streams extracted from video data and parsed to generate the applicable metadata. In addition, behavioral data may include clustering of player profiles and activity, e.g., analyzing one or more aspects of players in relation to other players, other players' actions, their provided user identifiers, other identifying information, gaming activity, and similar information. AB testing of features can also occur.

Artificial intelligence and machine learning aspects can also be applied to address predictions versus recommendation and provided either or both in real time. For example, reinforcement learning can be applied to optimize next steps. In an example, a user action during game play triggers certain responses. Such data may be analyzed by present systems and methods in order to optimize next steps, user game play, gaming experience, and other aspects of the user game play and play processing. Auto Regressive Integrated Moving Average (ARIMA) and Deep Learning modules and methods can also be applied to the meta data obtained from the gaming video streams. Any of a plurality of computer programs, algorithms, and methods may be applied to optimize the meta data analysis and real-time application of embodiments discussed herein.

In yet another embodiment, AI strategies may be implemented in order to help the player during game play, such as an Artificial Intelligence assistant. The AI assistant can learn about user game play, patterns, and behaviors, to further augment player experience. In such examples, there may be both human and machine augmentation, and Bayesian Analyses can be used in relevant implementations. The user experience, game play, and even processing of one or more aspects of the gaming events can be thus improved through such strategies.

The following tables provide additional information regarding various components of the inventive system, including aspects of the data flow.

Table 1 illustrates various aspects regarding the video acquisition, data processing, and machine learning/data analysis that can occur in various embodiments of disclosed systems and methods. With regard to the video acquisition, such implementations may be any of a plurality of video systems, video displays, gaming consoles, video types, files, streams, etc., operating on one or more computing systems and displays, via one or more networks. It will be appreciated that the video streams, data processing, and machine learning/data analyses are not limited to the examples provided in the tables below, but may comprise any of a plurality of video and computing systems known to those skilled in the art.

TABLE 1

| | | Machine Learning/ |
|---|---|---|
| Video Acquisition | Data Processing | Data Analysis |
| Sequence of Images - | Video Camera | Game Data Mining |
| 25 Images Per Second | Capture Frames | Match or |
| Dimension of Images - | from Video stream. | Tournament |
| 640 × 480 | Video Sensor | Winner/Loser |
| Memory Required | Process the Frames | Verification |
| 2 Hour Movie - | Mask to perform | Perform |
| 200 GB Bytes | background | Sequence |
| Video Compression | subtraction | modeling of |
| Spatial Redundancy - | Video Detector | Player |
| Coding each frame | Determines | Behavior |
| by means of | Region of | Real Time |
| JPEG. | Interest (Scores) | Odds Prediction |
| Temporal | | Simulate Real |
| Redundancy - | | Scenarios |
| Consecutive | | What - If |
| Frames are | | Analysis |
| often almost | | Player Data Mining |
| the same. | | Player |
| | | Categorization |
| | | Player |
| | | Attrition |
| | | Leaderboard |
| | | Chances |

Table 2 expands upon the machine learning and data analysis methods discussed above. As described in FIG. 3, such algorithms can include aspects related to behavioral machine learning, predicting play time, and providing artificial intelligence assistance.

TABLE 2
Machine Learning/Data Analysis

| Behavioral | | |
|---|---|---|
| Machine Learning | Predicting Play Time | AI Assistance |
| Clustering | Play Time Prediction | Bayesian Analysis |
| Based on players | Forecasting playtime | Help players |
| behavior categories | of players using | using dynamic |
| different players - | ARIMA and Deep | Bayesian network |
| Using K-Means, GMM | Learning | model and |
| and other techniques. | All about understanding | network analysis |
| Better performing | playtime using model | Voice Assistance |
| techniques using | interpretability | AI Voice assistance |
| robust models | Player Attrition | complementing |
| One of the use | Real Time score for | Chatbots |
| cases can be | player attrition | ChatBot |
| Recommending | using cutting edge | ChatBot for |
| Opponents | machine learning | Players to help |
| Strategy Identification | models. | better strategies. |
| Identify aggressive | Machine Learning | |
| and defensive mode | Interpretability | |
| players using | for all the models | |
| sequence modeling - | to deeper | |
| HMM. | understanding | |
| Causality Analysis | Next Step Optimization | |
| using economics | Reinforcement Learning | |
| theory. | for next step | |
| Event time series | optimization for | |
| analysis to understand | players | |
| player behavior | One of the use cases | |
| (aggressive at | can be recommending | |
| what stage) | next steps to win | |

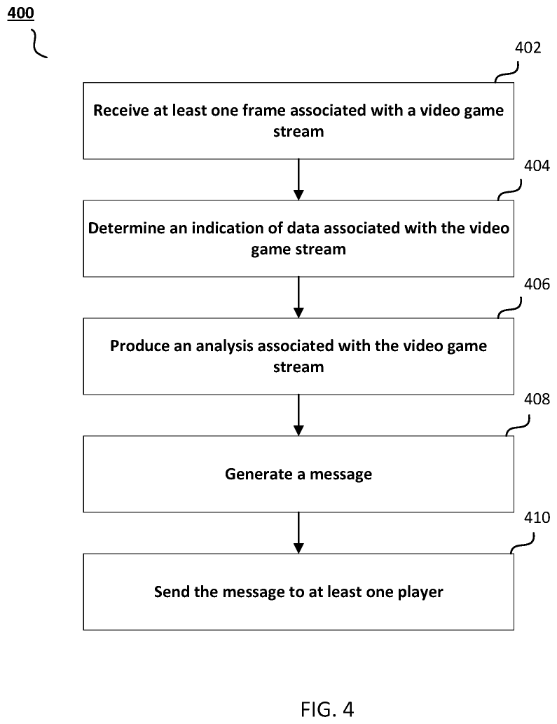

FIG. 4 illustrates an exemplary method of video analysis 400 in accordance with embodiments discussed herein. In embodiments, at least one frame associated with a video game stream is received 402. The frame may be received by a computing system local or remote to the device on which game play is occurring. Based on the at least one frame, a determination is made regarding an indication of data associated with the video game stream 404. Then, an analysis associated with the video game stream 406 occurs. Such analyses may be in accordance with any of those discussed with respect to FIGS. 2-3, identifying aspects of game play, user information, etc.

Based on the indication of data, an analysis associated with the video game stream is produced. In examples, this can include at least one of a game strategy, behavioral information, a prediction, or a recommendation. Then, a message is generated to be output to a user via the gaming device, e.g., video game stream. The message is based on the analysis associated with the video game, and may include a wagering recommendation, game play recommendation, or action recommendation to one or more players. In examples the message can be an audio file, a video file, or other visual or tactile indication provided to the player.

In various embodiment, the data associated with the video game stream comprises at least one of a game score, player information, and scene information. The scene information can further indicate how the at least one player of the video game stream performs against other users of various skill levels. In another example, player information comprises at least one of a gamer tag or a username for the at least one player of the video game stream. In each of these examples, the video game stream may be a live stream, although the present invention is not limited to live gaming streams and can be applied to a plurality of other gaming systems, methods, and types.

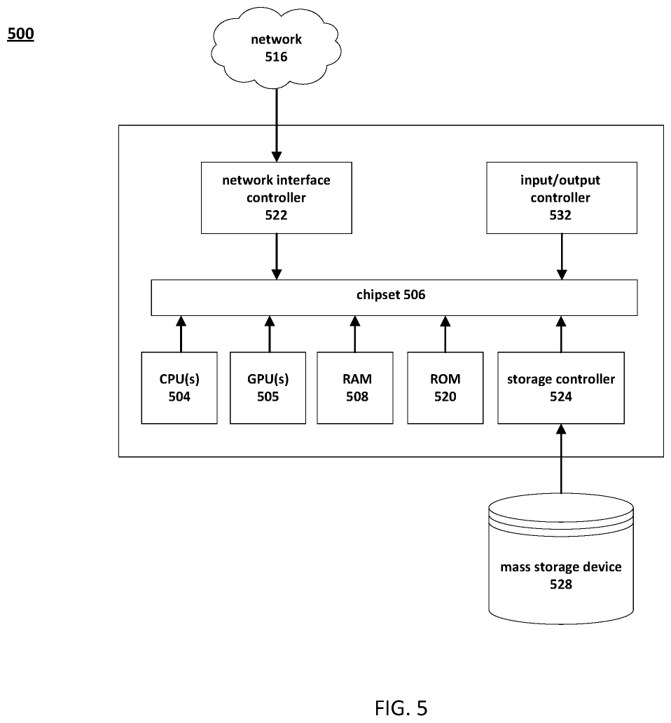

FIG. 5 depicts a computing device that may be used in various aspects, such as the devices depicted in FIG. 1. The computer architecture shown in FIG. 5 shows a conventional server computer, workstation, desktop computer, laptop, tablet, network appliance, PDA, e-reader, digital cellular phone, or other computing node, and may be utilized to execute any aspects of the computers described herein, such as to implement the method described in FIG.

The computing device 500 may include a baseboard, or “motherboard,” which is a printed circuit board to which a multitude of components or devices may be connected by way of a system bus or other electrical communication paths. One or more central processing units (CPUs) 504 may operate in conjunction with a chipset 506. The CPU(s) 504 may be standard programmable processors that perform arithmetic and logical operations necessary for the operation of the computing device 500.

The CPU(s) 504 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 504 may be augmented with or replaced by other processing units, such as GPU(s) 405. The GPU(s) 505 may comprise processing units specialized for but not necessarily limited to highly parallel computations, such as graphics and other visualization-related processing.

A user interface may be provided between the CPU(s) 504 and the remainder of the components and devices on the baseboard. The interface may be used to access a random access memory (RAM) 508 used as the main memory in the computing device 500. The interface may be used to access a computer-readable storage medium, such as a read-only memory (ROM) 520 or non-volatile RAM (NVRAM) (not shown), for storing basic routines that may help to start up the computing device 500 and to transfer information between the various components and devices. ROM 520 or NVRAM may also store other software components necessary for the operation of the computing device 500 in accordance with the aspects described herein. The user interface may be provided by a one or more electrical components such as the chipset 506.

The computing device 500 may operate in a networked environment using logical connections to remote computing nodes and computer systems through local area network (LAN) 516. The chipset 506 may include functionality for providing network connectivity through a network interface controller (NIC) 522, such as a gigabit Ethernet adapter. A NIC 522 may be capable of connecting the computing device 500 to other computing nodes over a network 516. It should be appreciated that multiple NICs 522 may be present in the computing device 500, connecting the computing device to other types of networks and remote computer systems.

The computing device 500 may be connected to a storage device 528 that provides non-volatile storage for the computer. The storage device 528 may store system programs, application programs, other program modules, and data, which have been described in greater detail herein. The storage device 528 may be connected to the computing device 500 through a storage controller 524 connected to the chipset 506. The storage device 528 may consist of one or more physical storage units. A storage controller 524 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 500 may store data on a storage device 528 by transforming the physical state of the physical storage units to reflect the information being stored. The specific transformation of a physical state may depend on various factors and on different implementations of this description. Examples of such factors may include, but are not limited to, the technology used to implement the physical storage units and whether the storage device 528 is characterized as primary or secondary storage and the like.

For example, the computing device 500 may store information to the storage device 528 by issuing instructions through a storage controller 524 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 500 may read information from the storage device 528 by detecting the physical states or characteristics of one or more particular locations within the physical storage units.

In addition or alternatively to the storage device 528 described herein, the computing device 500 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 500.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A storage device, such as the storage device 528 depicted in FIG. 5, may store an operating system utilized to control the operation of the computing device 500. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The storage device 528 may store other system or application programs and data utilized by the computing device 500.

The storage device 528 or other computer-readable storage media may also be encoded with computer-executable instructions, which, when loaded into the computing device 500, transforms the computing device from a general-purpose computing system into a special-purpose computer capable of implementing the aspects described herein. These computer-executable instructions transform the computing device 500 by specifying how the CPU(s) 504 transition between states, as described herein. The computing device 500 may have access to computer-readable storage media storing computer-executable instructions, which, when executed by the computing device 500, may perform the method described in relation to FIG. 4.

A computing device, such as the computing device 500 depicted in FIG. 5, may also include an input/output controller 532 for receiving and processing input from a number of input devices, such as a keyboard, a mouse, a touchpad, a touch screen, an electronic stylus, or other type of input device. Similarly, an input/output controller 532 may provide output to a display, such as a computer monitor, a flat-panel display, a digital projector, a printer, a plotter, or other type of output device. It will be appreciated that the computing device 500 may not include all of the components shown in FIG. 5, may include other components that are not explicitly shown in FIG. 5, or may utilize an architecture completely different than that shown in FIG. 5.

As described herein, a computing device may be a physical computing device, such as the computing device 500 of FIG. 5. A computing node may also include a virtual machine host process and one or more virtual machine instances. Computer-executable instructions may be executed by the physical hardware of a computing device indirectly through interpretation and/or execution of instructions stored and executed in the context of a virtual machine.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed:

1. A method comprising:
receiving at least one frame associated with a video game stream;
determining, based on the at least one frame, an indication of data associated with the video game stream;
producing, based on the indication of data, an analysis associated with the video game stream, the analysis including at least one of a game strategy, behavioral information, a prediction, and a recommendation;
generating, based on the analysis associated with the video game, a message; and
sending, to at least one player of the video game stream, the message.

2. The method of claim 1, wherein the indication of data associated with the video game stream comprises at least one of a game score, player information, or scene information.

3. The method of claim 2, wherein the scene information indicates how the at least one player of the video game stream performs against other users of various skill levels.

4. The method of claim 2, wherein the player information comprises at least one of a gamer tag or a username for the at least one player of the video game stream.

5. The method of claim 1, wherein the message includes a wagering recommendation.

6. The method of claim 1, wherein sending, to the player of the video game stream, the message comprises:
sending, to the player of the video game stream, the message as an audio file.

7. The method of claim 1, wherein the video game stream is a live stream.

8. A device comprising:
a video camera;
one or more processors; and
memory storing instructions that, when executed by the one or more processors, cause the device to:
receive, from the video camera, at least one frame associated with a video game stream;
determine, based on the at least one frame, an indication of data associated with the video game stream;
produce, based on the indication of data, an analysis associated with the video game stream, the analysis including at least one of a game strategy, behavioral information, a prediction, and a recommendation;
generate, based on the analysis associated with the video game, a message; and
send, to at least one player of the video game stream, the message.

9. The device of claim 8, wherein the indication of data associated with the video game stream comprises at least one of a game score, player information, or scene information.

10. The device of claim 9, wherein the scene information indicates how the at least one player of the video game stream performs against other users of various skill levels.

11. The device of claim 9, wherein the player information comprises at least one of a gamer tag or a username for the at least one player of the video game stream.

12. The device of claim 8, wherein the message includes a wagering recommendation.

13. The device of claim 8, wherein the device sends, to the player of the video game stream, the message as an audio file.

14. The device of claim 8, wherein the video game stream is a live stream.

15. A computer-readable medium storing instructions that, when executed, cause:
receiving at least one frame associated with a video game stream;
determining, based on the at least one frame, an indication of data associated with the video game stream;
producing, based on the indication of data, an analysis associated with the video game stream, the analysis including at least one of a game strategy, behavioral information, a prediction, and a recommendation;
generating, based on the analysis associated with the video game, a message; and
sending, to at least one player of the video game stream, the message.

16. The computer-readable medium of claim 15, wherein the indication of data associated with the video game stream comprises at least one of a game score, player information, or scene information.

17. The computer-readable medium of claim 16, wherein the scene information indicates how the at least one player of the video game stream performs against other users of various skill levels.

18. The computer-readable medium of claim 16, wherein the player information comprises at least one of a gamer tag or a username for the at least one player of the video game stream.

19. The computer-readable medium of claim 15, wherein the message includes a wagering recommendation.

20. The computer-readable medium of claim 15, wherein sending, to the player of the video game stream, the message comprises:
sending, to the player of the video game stream, the message as an audio file.
